(19) United States
(12) Patent Application Publication
(10) Pub. No.: US 2012/0067298 A1
(43) Pub. Date: Mar. 22, 2012

(54) DIAPER FOR A DOMESTICATED ANIMAL

(76) Inventor: Marsha Rich, Angola, IN (US)

(21) Appl. No.: 12/888,396

(22) Filed: Sep. 22, 2010

(51) Int. Cl. A01K 23/00; B23P 11/00; A01K 29/00

(52) U.S. Cl. 119/856; 119/868; 29/428

(57) ABSTRACT

A diaper is provided for a domesticated animal and includes a first portion and a second portion, each sized based on a circumference of a waist of the animal. The diaper includes a third portion to link the first portion and the second portion, and is sized based on a second distance from a location on a back of the animal within the circumference to a location on an underside of the animal within the circumference of the waist. The diaper further includes a hole formed within the third portion to pass the tail of the animal. A first edge of the tail opening is positioned based on a first distance from the back location to the first edge of the tail, and a second edge of the tail opening is positioned based on a mid-point of the second distance.

### BACKGROUND OF THE INVENTION

Domesticated animals, such as dogs, require an initial period to train to control incontinence until the dog is in a designated area, such as outdoors during a walk, for example. During this initial training period, the dog will not be able to control its incontinence, resulting in involuntary urination in unwanted areas, such as indoors, for example.

In order to address the incontinence issue during the initial training period, and a subsequent period if the dog's incontinence persists, several conventional systems have been proposed. For example, U.S. Pat. No. 4,917,683 to Thompson discloses a garment made of a one-piece absorbent pliable fabric covering the hindquarter of a female dog within a pair of openings for the dog's rear legs, an opening for the dog's tail, an elastic band for encircling the dog's loin area, and snaps for closing the garment at the dog's point of rump. The garment is disclosed as having one fixed size.

Although conventional systems have been proposed to address the incontinence issue of dogs, they have several shortcomings. For example, the garment disclosed in Thompson is formed to one fixed size. However, the size of each dog varies considerably, based on one or more of the breed, the gender, the weight and other factors. Thus, the conventional system fails to address the wide range of size and breed of each dog, to address the need for a diaper to form fit different breeds and permit natural freedom of movement.

Thus, it would be advantageous to provide a system which addresses the shortcomings of the conventional systems, by addressing the incontinence issue of dogs during the initial training period and thereafter, while also being adaptable to dogs of varying size and breed.

### BRIEF DESCRIPTION OF THE INVENTION

In one embodiment of the present invention, a method is provided for making a diaper to be worn by a domesticated animal. The method begins by measuring a waist circumference of the animal in a standing position. The method subsequently includes measuring a first distance from a location on a center portion of a back of the animal within the waist circumference to a first edge of a tail of the animal. The method subsequently includes measuring a second distance including the first distance and an additional distance from the first edge of the tail to a location on a center portion of the underside of the animal within the waist circumference. The method subsequently includes sizing a first portion and a second portion of the diaper based on the waist circumference and breed. The first portion and the second portion are arranged with a parallel orientation and are linked together by a third portion of the diaper. The method subsequently includes sizing the third portion of the diaper based on the second distance. The method subsequently includes positioning a hole within the third portion to pass a tail of the animal. A length of the hole along the third portion is based on a first edge of the hole spaced from an edge of the second portion by the first distance, and a second edge of the hole positioned to coincide with a midpoint of the third portion. The method subsequently includes positioning a removable insert at a location between the second edge of the hole and an edge of the first portion.

In another embodiment of the present invention, a diaper is provided for a domesticated animal. The diaper includes a first portion and a second portion, where the first portion and the second portion are sized based on a circumference of a waist of the animal and breed. The diaper further includes a third portion to link the first portion and the second portion together. The third portion is sized based on a second distance from a location on a back of the animal within the circumference of the waist to a first edge of a tail and to a location on an underside of the animal within the circumference of the waist. The diaper further includes a hole formed within the third portion to pass the tail of the animal. A first edge of the tail opening is positioned based on a first distance from the location on the back of the animal to the first edge of the tail, and a second edge of the tail opening is positioned based on a mid-point of the second distance.

In another embodiment of the present invention, a diaper is provided for a domesticated animal. The diaper includes a waist strip and a base strip, where the respective length of the waist strip and the base strip is based on a circumference of a waist of the animal. The diaper further includes an intermediate strip to connect the waist strip to the base strip. The intermediate strip has a length based on a distance from a location on a back of the animal within the circumference of the waist through rear legs of the animal and to a location on an underside of the animal within the circumference and breed. The diaper further includes a hole formed within the intermediate strip to pass a tail of the animal. The hole is positioned based on a distance from the location on the back to a first edge of the tail and the distance from the location on the back to the location on the underside of the animal.

### BRIEF DESCRIPTION OF THE DRAWINGS

FIG. 1 is a side perspective view of a dog on which an exemplary embodiment of the diaper illustrated in FIG. 2 is positioned;

FIG. 2 is a top view of an exemplary embodiment of a diaper in accordance with the present invention, to be positioned on a female dog in FIG. 1;

FIG. 3 is a top view of an exemplary embodiment of a diaper in accordance with the present invention, to be positioned on a female dog of a boxer breed;

FIG. 4 is a top view of an exemplary embodiment of a diaper in accordance with the present invention, to be positioned on a male dog in FIG. 1;

FIG. 5 is a side perspective of the diaper illustrated in FIG. 2 being worn by the dog in FIG. 1;

FIG. 6 is a side perspective view of various dog breeds on which an exemplary embodiment of the diaper illustrated in FIG. 2 is positioned; and

FIG. 7 is a flowchart depicting an exemplary embodiment of a method for making the diaper illustrated in FIG. 2.

### DETAILED DESCRIPTION

The embodiments of the present invention discuss a diaper to be used with a domesticated animal, such as a dog, a cat, or any other domesticated animal sharing the same four-leg vertebrae frame. Throughout the specification, an example of a dog will be used, but this is not limiting and the embodiments of the invention may be used to make a diaper for any domesticated animal. As discussed below, the embodiments of the present invention provide a method for specifically sizing each portion of the diaper, based on specific measurements taken of a dog. The dog has one or more identity characteristics, including breed, gender, weight, age and other characteristics. Each diaper is then designated as being tailored to a dog with the same identity characteristics as the measured dog, including one or more of breed, gender, weight, age and other characteristics.

FIG. 1 illustrates an exemplary embodiment of a dog 12 with one or more identity characteristics, including one or more of breed, gender, weight, age and other characteristics. The embodiments of the present invention provide a method 100 during which various specific measurements of the dog 12 are taken, and are subsequently used to form a diaper 10 which is used to fit the dog 12, and other dogs having one or more of the same identity characteristics of the dog 12.

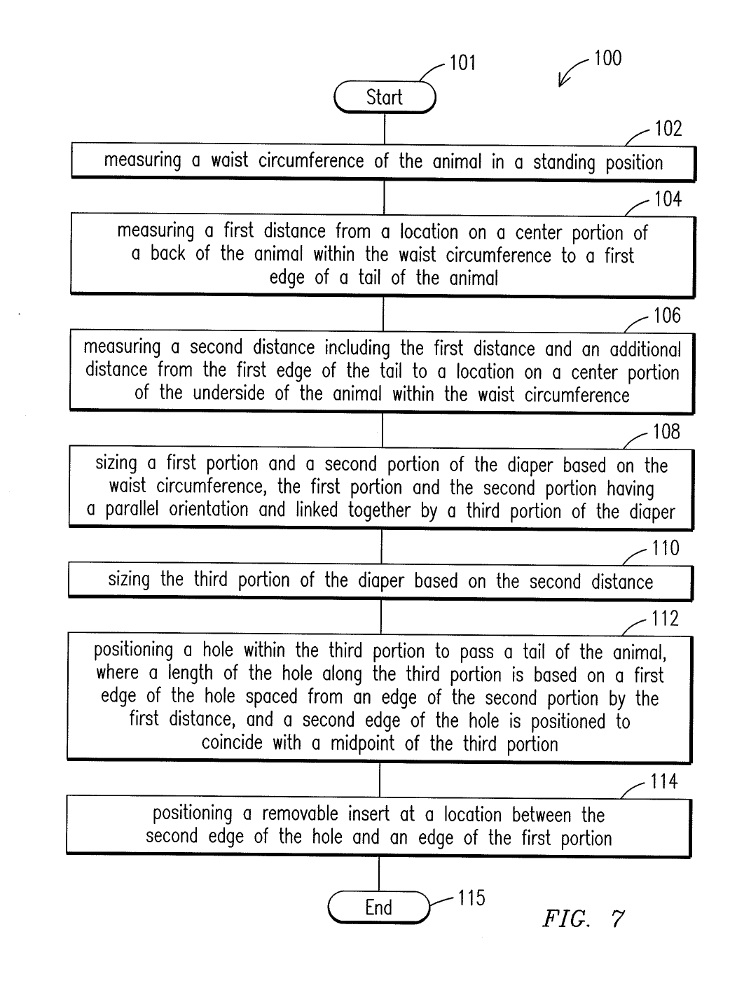

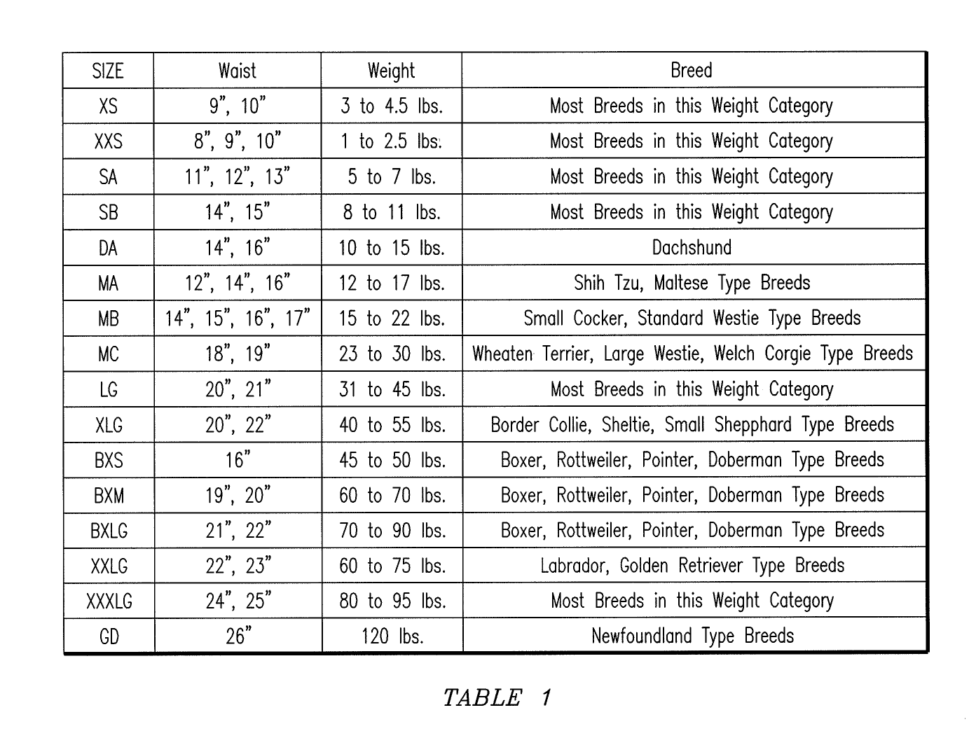

FIG. 7 depicts a flowchart of a method 100 for making a diaper 10 to be worn by the dog 12. The method 100 starts at 101 by measuring 102 a waist circumference 18 of the dog 12 in a standing position. As illustrated in FIG. 1, the waist circumference 18 is measured around the torso of the dog 12, near the juncture of the dog's rear legs and the lower torso. However, the waist circumference 18 need not be measured in this specific location on the dog 12, and may be measured in alternate locations along the torso. After the waist circumference 18 is measured, the method 100 subsequently includes measuring 104 a first distance 21 from a location 24 on a center portion of a back of the dog 12 within the waist circumference 18 to a first edge 26 of a tail 32 of the dog 12. In an exemplary embodiment, the location 24 on the center portion of the back of the dog 12 may coincide with a spinal axis of the dog, positioned along a center region of the back. The method 100 subsequently includes measuring 106 a second distance 22 which includes the first distance 21 and an additional distance from the first edge 26 of the tail 32 through the dog's legs and to a location 28 on a center portion of the underside of the dog 12 within the waist circumference 18. In an exemplary embodiment of the present invention, the location 28 on the underside of the dog 12 is positioned approximately underneath the location 24 on the back of the dog 12, and both locations 24,28 are within the waist circumference 18. However, as discussed above, the waist circumference need not be measured in the location illustrated in FIG. 1, and thus the locations on the underside and the back that are within the waist circumference need not be in the same locations as those illustrated in FIG. 1.

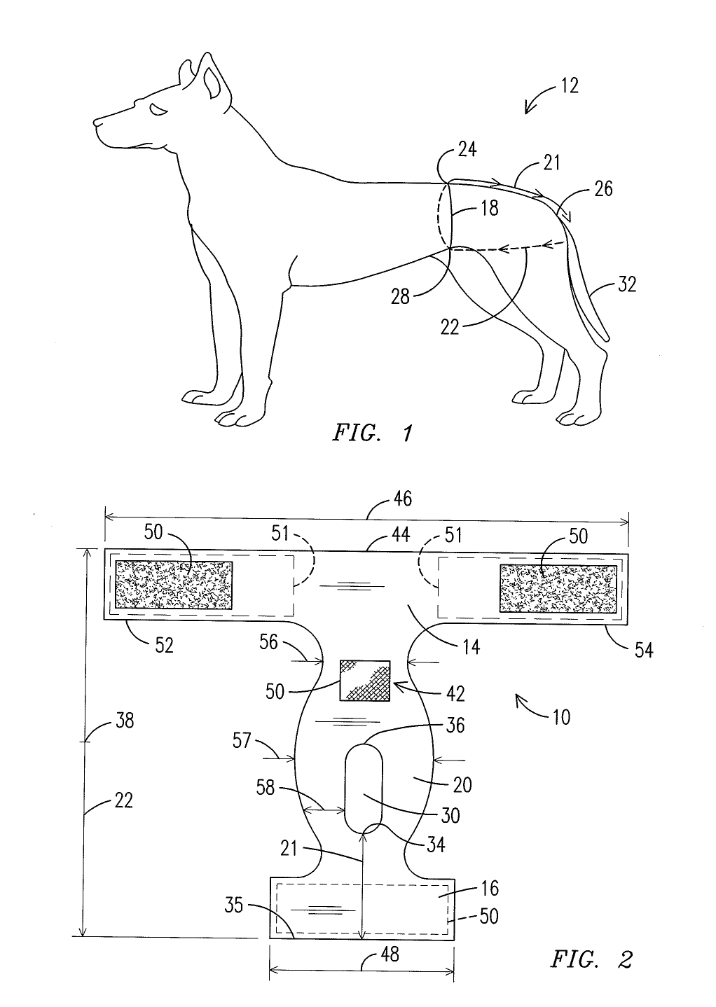

After the above measurements along the dog 12 are performed, the diaper 10 may be formed, including sizing various portions 14,16,20 of the diaper 10. The method 100 subsequently includes sizing 108 a waist strip or a first portion 14 (FIG. 2) and a base strip or a second portion 16 of the diaper 10, based on the waist circumference 18. In an exemplary embodiment, the sizing of the first portion 14 and second portion 16 is based on a length 46 of the first portion 14 corresponding to the waist circumference 18. As illustrated in FIG. 2, the first portion 14 and the second portion 16 include a hook and loop material 50, such as Velcro®, for example. When the diaper 10 is positioned on the dog 12, the center of the first portion 14 is positioned near the location 28 on the underside of the dog 12, after which the third portion 20 is folded up through the dog's legs, the dog's tail 32 is passed through the hole 30 and the second portion 16 is positioned near the location 24 on the back of the dog 12. After the second portion 16 is positioned near the location 24 on the back of the dog 12, the hook and loop material 50 on each opposing end 52,54 of the first portion 14 is folded onto the hook and loop material 50 of the second portion 16, and the hook and loop material 50 of the second portion 16 secures to the hook and loop material of the first portion 14. When the ends 52,54 of the first portion 14 overlap with the second portion 16, the length of the combination of the secured first and second portions 14,16 is equal to the length 46 of the first portion 14 and thus, is equal to the waist circumference 18. FIG. 2 illustrates an optional variation of the hook and loop material 51 which extends along the opposite ends 52,54 of the first portion 14 by a length which equals the length 48 of the second portion 16, where one of the opposite ends 52,54 is provided with a double-sided hook and loop material 51 on both sides of the first portion 14. Thus, with this optional design modification, when the diaper 10 is positioned on the dog 12, the second portion 16 is passed up through the dog's legs and near the location 24 on the back of the dog 12, after which the end 52,54 with the double-sided hook and loop material 51 is folded over to cover and attach to the second portion 16, and the other end 52,54 is folded over to cover and attach to the end 52,54 with the double-sided hook and loop material. As a result of the design of the optional variation of the first portion 14, the difference in the length 46 of the first portion 14 and the length 48 of the second portion 16 is based on the waist circumference 18, and this difference is equal to the waist circumference 18. The optional design of the first portion 14 permits a variation of choices for the length 46 of the first portion and the length 48 of the second portion 16, based on how rigid or secure the diaper 10 must be worn on the dog 12. One of skill in the art may vary the length 48 of the second portion 16 (and correspondingly increase the length 46 of the first portion 14), to correspondingly vary how rigid or secure the diaper 10 is on the dog 12, based on various factors, such as an identity characteristic of the dog 12, such as one or more of breed, gender, weight, age, and other characteristics. For example, the length 48 of the second portion 16 may be increased if the breed of the dog 12 demonstrates a behavioral tendency to hide in tight areas, and thus require an increased security of the diaper 10 on the dog 12. Thus, for example, if the waist circumference is measured to be 10 inches, the length 46 of the first portion 14 may be sized to be 14 inches, and the length 48 of the second portion 16 may be sized to be 4 inches. In this example, one end 52,54 of the first portion 14 is provided with double-sided hook and loop material with a length of 4 inches, which secures to the second portion 16 on one side and to the other end 52,54 of the first portion 14 on another side, and thus the secured first and second portion 14,16 have a combined length equal to the waist circumference.

As illustrated in FIG. 2, the first portion 14 and the second portion 16 of the diaper 10 are oriented to have a parallel orientation, before the diaper 10 is fitted onto the dog 12. However, the first portion 14 and the second portion 16 of the diaper 10 need not have a parallel orientation, and may be oriented in a non-parallel orientation, for example. Additionally, as illustrated in FIG. 2, the first portion 14 and the second portion 16 are linked together by the third portion 20, which is joined to the first portion 14 and the second portion 16 in an approximately orthogonal orientation. Although the third portion 20 joins the first portion 14 and the second portion 16 together at an orthogonal orientation, the third portion need not be oriented with such an orthogonal orientation and may be oriented at a non-orthogonal orientation, with respect to the first portion 14 and the second portion 20 of the diaper 10.

As illustrated in the flowchart of FIG. 7, after the first and second portions 14,16 have been sized, the method subsequently includes sizing 110 the third portion 20 of the diaper 10, based on the second distance 22 measured from the location 24 on the back of the dog 12 to the location 28 on the underside of the dog 12. In an exemplary embodiment, the length of the third portion 20 is the second distance 22. However, the third portion 20 of the diaper 10 is not limited to having a length equal to the second distance, and the length may be less or more than the second distance. The method for making the diaper 10 subsequently includes positioning 112 a hole 30 within the third portion 20 to pass the tail 32 of the dog 12. As discussed above, the diaper 10 is initially positioned with the center of the first portion 14 aligned with the location 28 on the underside of the dog 12, and the third portion 20 is folded upward through the legs of the dog 12 such that the tail 32 passes through the hole 30 in the third portion 20. As illustrated in FIG. 2, the length of the hole 30 along the third portion 20 is based on a first edge 34 of the hole 30 that is spaced from an edge 35 of the second portion 16 by the first distance 21, and a second edge 36 of the hole 30 that is positioned to coincide with a midpoint 38 of the length (i.e., second distance 22) of the third portion 20. Although the embodiment of the present invention illustrates the specific first and second edge 34,36 of the hole 30 and the above discussion specifies how each edge 34,36 is sized based on the measurements taken of the dog 12, the embodiments of the present invention is not limited to this specific approach for determining the size and location of the hole 30, and may include other alternate methods which may determine an appropriate size and location of the hole 30 which provides adequate comfort to the dog and security to prevent the diaper 10 from sliding off the dog 12.

After the hole 30 has been positioned within the diaper 10, the method 100 subsequently includes the step of positioning 114 a removable insert 42 at a location between the second edge 36 of the hole 30 and an edge 44 of the first portion 14. As illustrated in FIG. 2, the location of the removable insert 42 includes a hook and loop material 50 on the surface of the third portion 20 which attaches to a hook and loop material 50 of the removable insert 42, when the removable insert 42 is adhered to the third portion 20 at the location illustrated in FIG. 2. The material of the removable insert 42 is a material capable of absorbing the urine from the dog, such as a female sanitary pad, for example. The removable insert is disposable and easily replaceable by the dog owner, after the dog excretes liquid on the insert 42. The diaper 10 illustrated in FIG. 2 is a standard female diaper, which provides for the removable insert 42 to be positioned at a location which is separated from the second edge 36 of the hole 30 by a ratio of the distance from the second edge 36 of the hole 30 to the edge 44 of the first portion 14 which is less than ½ (i.e., the removable insert 42 is positioned from the second edge 36 by less than half of the distance from the second edge 36 to the edge 44 of the first portion 14). As appreciated by one of skill in the art, the removable insert 42 is positioned at a distance closer to the second edge 36 than the edge 44, based on the anatomy of the female dog, and more specifically that the urinary tract will be correspondingly closer to the second edge 36 than the edge 44, when the diaper 10 is worn by the dog 12 as described in the embodiments of the present invention. In an exemplary embodiment, the ratio is less than ⅓. In another exemplary embodiment, the ratio is less than ¼. In another exemplary embodiment, the ratio is less than ⅕. In another exemplary embodiment, the ratio is less than ⅙. In another exemplary embodiment, the ratio is less than 1/7. After positioning 114 the removable insert 42, the method 100 ends at 115.

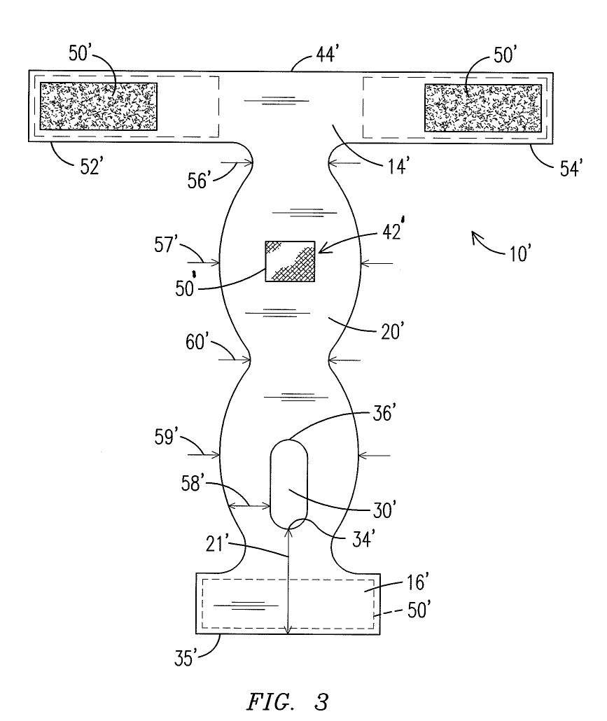

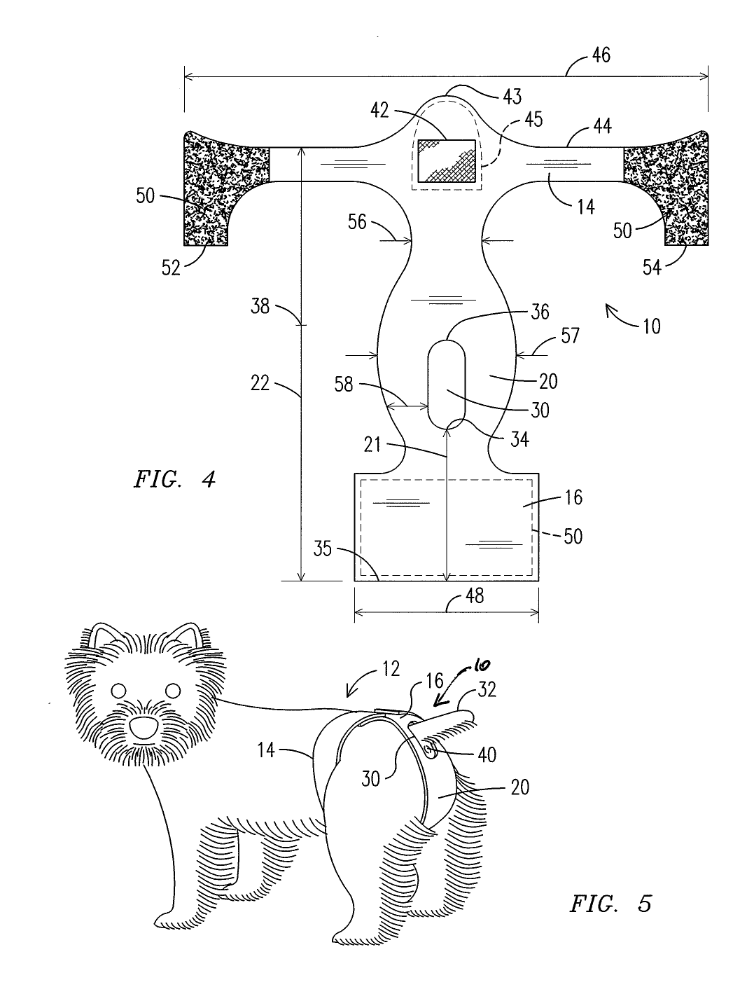

In addition to the measurements of the dog 12 discussed above, including the first distance 21, the second distance 22 and the locations 24,28, other factors may be used to form the diaper 10. For example, the shape of a breed of dog, such as a pitch of the back of the dog breed, may be utilized to form the diaper. FIG. 3 illustrates an exemplary embodiment of a female diaper 10′ which is made to fit a female boxer breed dog. As illustrated in FIG. 3, the diaper 10′ is similar to the standard female diaper 10 in FIG. 2, but includes various design modifications, based on the shape of the boxer breed dog. As illustrated in FIG. 3, the profile of the third portion 20′ of the diaper 10′, unlike the third portion 20 of the diaper 10, includes more than one minimum width 56′,60′ where the width of the third portion 20′ is greater on either side of the minimum width 56′,60′. Additionally, the third portion 20′ includes more than one maximum width 57′,59′, where the width of the third portion 20′ is less on either side of the maximum width 57′,59′. As discussed below, the third portion 20 of the diaper 10 in FIG. 2 has one maximum width 57 and one minimum width 56, and thus the profile of the third portion 20′ of the diaper 10′ is modified, to accommodate the female boxer breed. Additionally, the length of the third portion 20′ may be greater than the length of the third portion 20, for example.

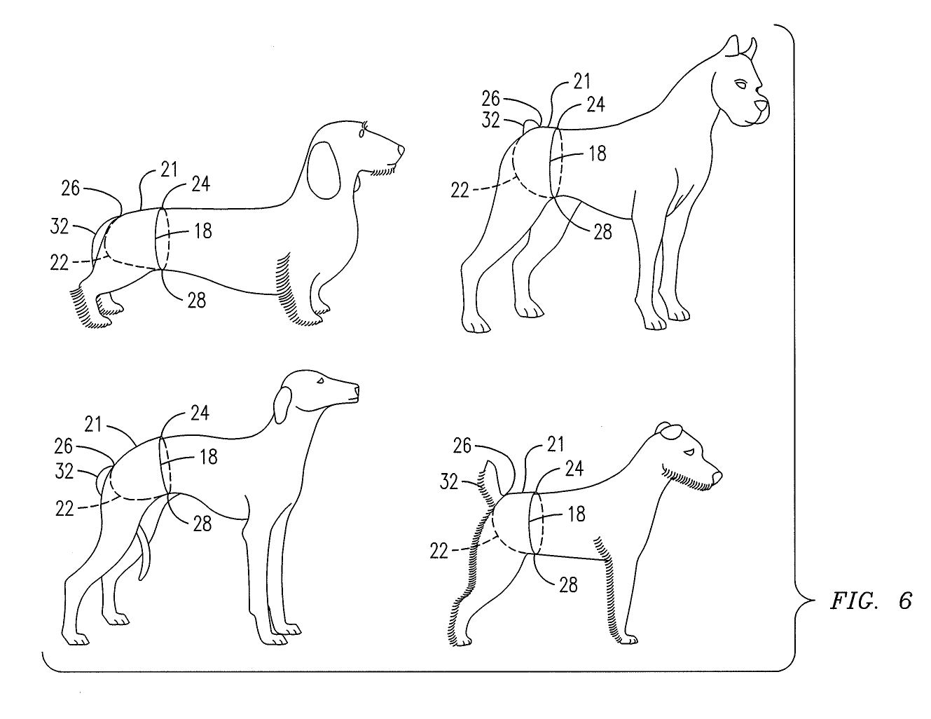

The diaper 10 illustrated in FIG. 4 is a standard male diaper 10, which provides for the removable insert 42 to be positioned at a location which is separated from the edge 44 of the first portion 14 by a distance, such as ½″ for example. As illustrated in FIG. 4, a center layer 45 is provided within the first portion 14 at the location where the removable insert 42 is attached to the first portion 14. The center layer 45 is made from a material to provide structural integrity to the first portion 14 and the diaper 10 in the region where the removable insert 42 is attached to the first portion 14. As further illustrated in FIG. 4, the edge 44 of the first portion 14 extends to a ridge 43 in a region near the center of the first portion 14, and the removable insert 42 is separated from the ridge 43, in the direction of the third portion 20, by the distance, such as ½″, for example. Although the above embodiment provides one numerical example for the separation of ½″ from the ridge 43 to the removable insert 42, the embodiments of the present invention is not limited to this specific distance, and may be less or more than ½″, for example. As appreciated by one of ordinary skill in the art, the removable insert 42 is positioned at a distance relatively close to the edge 44, based on the anatomy of the male dog, and more specifically such that the urinary tract will be correspondingly close to the edge 44, when the diaper 10 is worn by the dog 12 as described in the embodiments of the present invention.

As illustrated in FIG. 2, the minimum width 56 of the third portion 20 is less than a maximum width 57 of the third portion 20, and more specifically at the second edge 36 of the hole 30. In an exemplary embodiment, a width 58 of the third portion 20 on an outside of the hole 30 is designed to be greater than a threshold width. In an exemplary embodiment, the width 58 is designed to be greater than half of the width of the hole 30. However, this threshold width is merely exemplary and the threshold width may be less or more than half of the width of the hole, for example.

For each diaper 10 that is made using the method 100 of the present invention, the measurements of the dog 12 (including the circumference 18, first distance 21, second distance 22, and locations 24,28) and the dimensions of the diaper 10 (including the lengths 22,46,48; widths 56,57,58) are recorded, along with one or more identifying characteristics of the dog 12, including one or more of breed, gender, weight, age, and other characteristics. A database is created which is searchable based on one or more of the identifying characteristics of breed, gender, weight, age and other characteristics, in order to retrieve the previously-determined measurements of the dog with those same identifying characteristics and the dimensions of the diaper which fits the dog. Additionally, using the database, diapers with a respective set of dimensions may be pre-manufactured and sold to an owner of a dog whose one or more identifying characteristics match the one or more identifying characteristics associated with the manufactured diaper from the database. Table 1 provides an example of such a database, which provides a list of respective diaper sizes, based on specific waist circumferences, specific weight and/or the specific breed of the dog. The specific breed of the dog is restricted for each diaper size, as each specific weight for each respective diaper size necessarily excludes a range of dog breeds which fall outside this specific weight. Although Table 1 provides specific diaper sizes based on specific waist circumferences, specific weight and/or specific breeds of dog, Table 1 is merely exemplary and thus the embodiments of the present invention is not limited to the numerical sizes and weights listed in Table 1. Additionally, the diaper size within the database may be based on less or more identifying characteristics than those listed in Table 1.

FIG. 6 illustrates one or more breeds of dog, including (clockwise from top-left) a Dachshund, a Boxer, a Greyhound and a Jack Russell, and the respective circumference 18, first distance 21, second distance 22, locations 24,28, and the tail edge 26 for each respective breed. For example, the boxer breed has a tail 32 which is positioned relatively proximate to the back of the dog, and thus the boxer breed has a relative small first distance 21 between the location 24 and the tail edge 26. In contrast, the greyhound breed has a tail 32 which lies relatively far from the back of the dog, and thus the greyhound breed has a relatively large first distance 21 between the location 24 and the tail edge 26. Accordingly, the first edge 34 of the diaper 10 for the greyhound breed will be positioned at a greater distance from the edge 35 of the second portion 16 than the first edge 34 of the diaper 10 for the boxer breed (for an equivalent weight dog). In an exemplary embodiment, in a comparison of breeds of equivalent weight—a first example is a comparison of a 15 pound Jack Russell and a 15 pound West-Highland Terrier. The Jack Russell is measured with a first distance of 4″, a second distance of 15″ and a waist circumference of 16″, while the West-Highland Terrier is measured with a first distance of 3.75″, a second distance of 13.5″ and a waist circumference of 17″. A second example is a comparison of a 16 pound Dachshund and a 16 pound Shih Tzu. The Dachshund is measured with a first distance of 3.5″, a second distance of 12″ and a waist circumference of 16″, while the Shih Tzu is measured with a first distance of 3″, a second distance of 13″ and a waist circumference of 15″. A third example is a comparison of a 50 pound Boxer and a 50 pound Border Collie. The Boxer is measured with a first distance of 5.25″, a second distance of 22.5″ and a waist circumference of 20″, while the Border Collie is measured with a first distance of 3.75″, a second distance of 18.5″ and a waist circumference of 21″. A fourth example is a comparison of a 60 pound Greyhound and a 60 pound Labrador. The Greyhound is measured with a first distance of 7″, a second distance of 21.5″ and a waist circumference of 18″, while the Labrador is measured with a first distance of 5″, a second distance of 20.25″ and a waist circumference of 22″. As previously discussed and illustrated in FIG. 6, it is apparent from these exemplary dimensions that the first distance 21, second distance 22 and waist circumference 18 can vary, even among breeds of equivalent weight. For example, the first distance 21 of the Greyhound is larger than the first distance 21 of the Labrador, due to the characteristics of the Greyhound breed, including the arch of the Greyhound's back and the location of the tail edge 26, for example.

FIG. 5 illustrates the dog 12 after the diaper 10 has been fitted. As illustrated in FIG. 2, the opening 30 is oval-shaped, where the length of the opening 30 along the third portion 20 is based on the first edge 34 and the second edge 36, whose locations are determined based on the steps of the method 100 previously discussed. As illustrated in FIG. 5, after the opening 30 has been sized, based on the method 100 discussed above, the length of the tail opening 30 along the third portion 20 will be sufficient to enclose a circumference of the tail 32 and an anus 40 of the dog 12. By designing the length of the tail opening 30 along the third portion 20 to be large enough to enclose the anus 40, the dog 12 is permitted to pass a bowel movement through the tail opening 30 without soiling the inside of the diaper 10.

This written description uses examples to disclose embodiments of the invention, including the best mode, and also to enable any person skilled in the art to make and use the embodiments of the invention. The patentable scope of the embodiments of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method for making a diaper to be worn by a domesticated animal, said method comprising:
measuring a waist circumference of the animal in a standing position;
measuring a first distance from a location on a center portion of a back of the animal within the waist circumference to a first edge of a tail of the animal;
measuring a second distance including the first distance and an additional distance from the first edge of the tail to a location on a center portion of the underside of the animal within the waist circumference;
sizing a first portion and a second portion of the diaper based on the waist circumference, said first portion and said second portion having a parallel orientation and linked together by a third portion of the diaper;
sizing the third portion of the diaper based on the second distance;
positioning a hole within the third portion to pass a tail of the animal, wherein a length of the hole along the third portion is based on a first edge of the hole spaced from an edge of the second portion by the first distance, and a second edge of the hole positioned to coincide with a midpoint of the third portion; and
positioning a removable insert at a location between the second edge of the hole and an edge of the first portion.

2. The method of claim 1, wherein said animal is a dog.

3. The method of claim 1, wherein said first portion and said second portion include a hook and loop material; wherein upon folding the third portion such that the second portion overlaps with the first portion, the hook and loop material of the second portion is configured to secure to the hook and loop material of the first portion such that the length of the secured first and second portion is the waist circumference.

4. The method of claim 3, wherein said first portion includes opposite ends having hook and loop material; wherein said opposite ends of the first portion fold onto the second portion such that the hook and loop material of the opposite ends of the first portion secure to the hook and loop material of the second portion.

5. The method of claim 4, wherein said hook and loop material covers a first region of the opposite ends of the first portion and a second region of the second portion; and wherein dimensions of said first and second region are adjusted based on a behavioral characteristic of the animal to vary a level of security of the first region to the second region.

6. The method of claim 1, wherein a length of said third portion is based on the second distance, and wherein said third portion is oriented to be orthogonal to the first portion and the second portion; a width of said third portion adjacent to said first and second portions is less than the width of said third portion at said second edge of hole; and wherein a width of the third portion on an outside of the hole is greater than a threshold width.

7. The method of claim 1, wherein said animal is a dog, said waist circumference, first distance, second distance is measured, and the first, second and third portion of the diaper is sized for a respective dog with at least one identity characteristic, said identity characteristic including a breed, a gender, a weight; said diaper is pre-formed for each respective dog with the at least one identity characteristic.

8. The method of claim 1, wherein said animal is a female dog, said removable insert is separated from the second edge of the hole by a ratio of the distance from the second edge of the hole to the edge of the first portion, said ratio is less than ½.

9. The method of claim 1, wherein said animal is a male dog, said removable insert is separated from the edge of the first portion by ½ inch.

10. The method of claim 1, wherein said animal is a dog, said opening of tail is oval-shaped, wherein the length of the tail opening along the third portion is sufficient to enclose a circumference of the tail and an anus of the dog, to permit the passage of a bowel movement through the tail opening.

11. A diaper for a domesticated animal, comprising:
a first portion and a second portion, said first portion and said second portion being sized based on a circumference of a waist of the animal;
a third portion configured to link the first portion and the second portion together, said third portion being sized based on a second distance from a location on a back of the animal within the circumference of the waist to a first edge of a tail and to a location on an underside of the animal within the circumference of the waist;
a hole formed within the third portion to pass the tail of the animal, a first edge of the tail opening positioned based on a first distance from the location on the back of the animal to the first edge of the tail, and a second edge of the tail opening positioned based on a mid-point of the second distance.

12. The diaper of claim 11, wherein said animal is a dog, said hole is sized with an oval-shaped opening to enclose the tail of the dog and an anus of the dog to permit the passage of a bowel movement.

13. The diaper of claim 11, further including a removable insert at a location between the second edge of the hole and an edge of the first portion.

14. The diaper of claim 11, wherein a difference in a length of the first portion and a length of the second portion is the waist circumference, said first and second portions include a hook and loop material, such that the hook and loop material of the second portion is configured to attach to the hook and loop material of the first portion such that the length of the attached first and second portion is the waist circumference.

15. The diaper of claim 14, wherein said first portion includes opposite ends having hook and loop material; said third portion is positioned on the animal such that the second portion overlaps with the first portion; and said opposite ends of the first portion fold onto the second portion such that the hook and loop material of the opposite ends of the first portion attach to the hook and loop material of the second portion.

16. The diaper of claim 11, wherein said third portion is oriented to be orthogonal to the first and second portion; a width of said third portion adjacent to said first and second portions is less than the width of said third portion at said second edge of hole; and wherein an outside width of the third portion on an outside surface of the hole is greater than a threshold width.

17. The diaper of claim 11, wherein said animal is a dog, said waist circumference, first distance, second distance is measured, and the first, second and third portion of the diaper is sized for a respective dog with at least one identity characteristic, said identity characteristic including a breed, a gender, a weight; said diaper is pre-formed for each dog with the at least one of breed, gender and weight.

18. The diaper of claim 11, wherein said animal is a female dog, said removable insert is separated from the second edge of the hole by a ratio of the distance from the second edge of the hole to the edge of the first portion, said ratio less than ½.

19. The diaper of claim 11, wherein said animal is a male dog, said removable insert is separated from the edge of the first portion by ½ inch.

20. The diaper of claim 11, wherein said animal is a dog, said opening of tail is oval-shaped, wherein a length of the tail opening is based on the first and second edge, such that the tail opening is sufficient to enclose a circumference of the tail and an anus of the dog, such that the tail opening securely fits around the tail and to permit the passage of a bowel movement.

21. A diaper for a domesticated animal, comprising:
a waist strip and a base strip, the respective length of the waist strip and the base strip is based on a circumference of a waist of the animal;
an intermediate strip to connect the waist strip to the base strip, said intermediate strip having a length based on a distance from a location on a back of the animal within the circumference of the waist through rear legs of the animal and to a location on an underside of the animal within the circumference; and
a hole formed within the intermediate strip to pass a tail of the animal, said hole positioned based on a distance from the location on the back to a first edge of the tail and the distance from the location on the back to the location on the underside of the animal.
